(19) United States
(12) Patent Application Publication
(10) Pub. No.: US 2026/0340253 A1
(43) Pub. Date: Oct. 29, 2026

(54) INTEGRATED CIRCUIT GATE SIZING FROM TIMING GRADIENTS

(71) Applicant: NVIDIA Corp., Santa Clara, CA (US)

(72) Inventors: Yi-Chen Lu, San Jose, CA (US); Haoxing Ren, Austin, TX (US)

(73) Assignee: NVIDIA Corp., Santa Clara, CA (US)

(21) Appl. No.: 19/389,402

(22) Filed: Nov. 14, 2025

Related U.S. Application Data
(60) Provisional application No. 63/720,384, filed on Nov. 14, 2024.
(60) Provisional application No. 63/752,465, filed on Jan. 31, 2025.

(51) Int. Cl. G06F 30/392; G06F 117/12

(52) U.S. Cl. CPC G06F 30/392; G06F 2117/12

(57) ABSTRACT

Mechanisms for timing analysis, timing driven component sizing, and timing driven component placement in integrated circuit designs, utilizing an arc-based weighting strategy guided by timing gradients, assigning weights to arcs based on their timing gradient contributions to global timing metrics.

### CROSS REFERENCE TO RELATED APPLICATIONS

This application claims priority and benefit under 35 U.S.C. 119(e) to U.S. application Ser. No. 63/752,465, “DIFFERENTIABLE CALIBRATION-BASED TIMING-DRIVEN PLACEMENT”, filed on Jan. 31, 2025, the contents of which are incorporated herein by reference in their entirety, and to U.S. application Ser. No. 63/720,384, “VLSI Gate Sizing by Accurate Timing Sensitivity from Timing Gradients”, filed on Nov. 14, 2024, the contents of which are incorporated herein by reference in their entirety, and to U.S. application Ser. No. 63/720,384, “A GPU-Accelerated Differentiable Statistical Static Timing Analysis Engine in Advanced Nodes”, filed on Nov. 14, 2024, the contents of which are incorporated herein by reference in their entirety.

### BACKGROUND

Traditional timing-driven placement mechanisms for Very Large Scale Integration (VLSI) physical design rely on net-weighting-based strategies, which adjust the weights of nets based on criticality. These methods may suffer from locality of slack-based adjustments, whereby net weights are primarily assigned based on the most critical sink of a net. Locality of slack-based adjustments leads to uniform weighting along the same worst critical path, ignoring the nuanced contributions of different arcs to global timing metrics like total negative slack (TNS).

Conventional net-weighting-based strategies may assign the same weight to all arcs in a net, which is suboptimal. In practice, only a subset of sinks in a net are timing-critical. Blindly forcing all pins closer together may degrade placement quality and increase wirelength unnecessarily.

Existing solutions fail to address these limitations effectively leading to suboptimal timing quality and larger half-perimeter wirelength.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a circuit configuration process in one embodiment.

FIG. 2 depicts additional aspects of a circuit configuration process in one embodiment.

FIG. 3 depicts the utilization of multiple execution threads to perform arrival time merging.

FIG. 4 and FIG. 5 depict additional aspects of logic to perform arrival time merging.

FIG. 6A and FIG. 6B depict, respectively, conventional arc weighting and an arc-based weighting strategy guided by timing gradients.

FIG. 7 depicts the determination of timing gradients in one embodiment.

FIG. 8 depicts a parallel processing unit in accordance with one embodiment.

FIG. 9 depicts a general processing cluster in accordance with one embodiment.

FIG. 10 depicts a memory partition unit in accordance with one embodiment.

FIG. 11 depicts a streaming multiprocessor in accordance with one embodiment.

FIG. 12 depicts a processing system in accordance with one embodiment.

FIG. 13 depicts an exemplary processing system in accordance with another embodiment.

FIG. 14 depicts a graphics processing pipeline in accordance with one embodiment.

FIG. 15 illustrates an exemplary data center 1500, in accordance with at least one embodiment.

### DETAILED DESCRIPTION

Disclosed herein are mechanisms for timing-driven placement in VLSI physical design that apply timing gradients for optimization. The disclosed mechanisms enable timing driven placement utilizing an arc-based weighting strategy guided by timing gradients. Specifically, the disclosed mechanisms assign weights to arcs based on their timing gradient contributions to global timing metrics, providing a more fine-grained and accurate optimization. Instead of uniform net weighting, the disclosed mechanisms apply pin-to-pin Manhattan distances weighted by their respective timing gradients, enabling more targeted improvements in timing.

The disclosed mechanisms determine timing gradients for each arc, reflecting their individual contributions to global timing metrics like total negative slack. Total negative slack is a timing metric used in circuit design for evaluating the timing performance of a digital circuit. It represents the cumulative amount by which the circuit's actual signal propagation delays exceed the required timing constraints, specifically in paths that violate the desired timing.

Total negative slack is calculated by summing the negative slacks across all timing paths that do not meet the required setup time. A higher total negative slack indicates more extensive timing violations, potentially impacting the performance and reliability of the circuit. Reducing total negative slack is often a critical goal during the design optimization phase to ensure timing closure.

Unlike conventional approaches, the disclosed mechanisms weight the Manhattan distances between driver and sink pins based on timing gradients and dynamically scale the timing objective relative to wirelength and density objectives by aligning their gradient magnitudes.

Prior approaches use static net weights, lacking this adaptive mechanism. The disclosed mechanisms apply differentiable timing analysis, enabling precise gradient computation. In contrast, prior methods use non-differentiable timing propagation, which restricts optimization flexibility. Also unlike conventional approaches, the disclosed mechanisms do not solely rely on potentially slower and less efficient CPU-based timing engines.

The disclosed mechanisms comprise a timing-driven placer that utilizes timing gradients for global placement optimization. In particular, the disclosed mechanisms implement an arc-specific weighting strategy guided by timing gradients. Instead of relying on “slack values”, the weighting strategy reflects each arc's contribution (i.e., gradient) to global timing metrics such as total negative slack. Pin-to-pin Manhattan distances are weighted by their respective timing gradients.

$${arrival\_mean}_{i} = {arrival\_mean}_{j} + {arc\_mean}_{j \to i}$$

$${arrival\_std}_{i}^{2} = {arrival\_std}_{j}^{2} + {arc\_std}_{j \to i}^{2}$$

$${arrival}_{i} = {arrival\_mean}_{i} + {N}_{σ} * {arrival\_std}_{i}$$

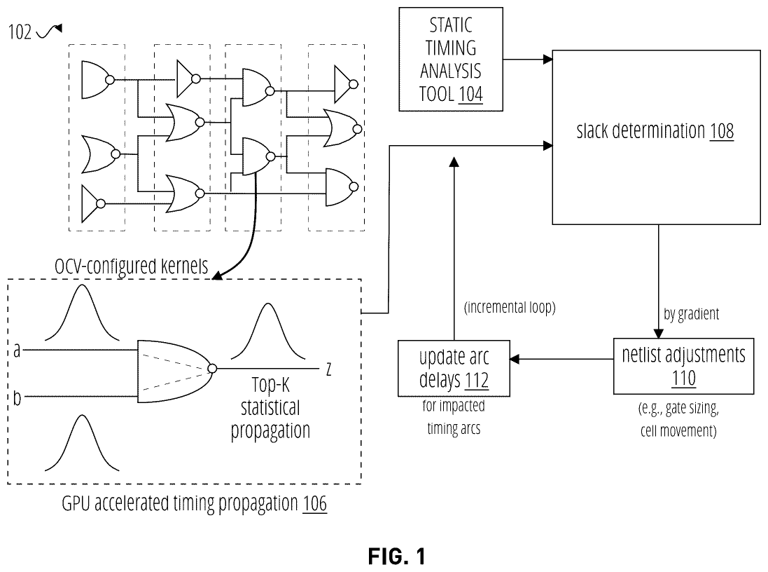

FIG. 1 depicts a circuit configuration process in one embodiment. The process begins with an initialization of timing characteristics of a circuit 102 from a reference static timing analysis tool 104 (e.g., PrimeTime). The process executes a fast, differentiable, and timing propagation analysis (timing propagation 106) utilizing, for example, kernels of a massively-parallel computing architecture (e.g., Nvidia's CUDA). Results of this analysis are highly correlated with output of the static timing analysis tool 104.

The process continues with slack determinations 108 for the circuit 102 based on gradient computation of global timing metrics (e.g., total negative slack) with respect to circuit features such as gate sizes and cell locations. These gradients quantify each variable's timing contribution and may be applied for netlist adjustments 110 such as component placement and sizing. Arc delays for the circuit 102 are updated (112) incrementally to account for the netlist adjustments 110.

The process may thus be utilized to achieve tool-accurate timing analysis that aligns with outputs of a reference static timing analysis tool, while enabling gradient-based optimization over various leaf variables (e.g., gate sizes, cell locations).

Achieving alignment presents challenges. Arc delays may be cloned from the static timing analysis tool 104 at process initialization, but replicating the exact timing propagation process requires careful handling of on-chip variation (OCV), common path pessimism removal (CPPR), and timing constraints, advantageously in a GPU-accelerated manner.

On-chip variation refers to the timing variations that occur across different regions of a large circuit or chip due to manufacturing process fluctuations. Even though a circuit or chip is fabricated as a unit, transistors and wires in different areas can end up with slightly different characteristics (e.g., threshold voltage, channel length, metal resistance). These variations can make some paths in a circuit faster or slower than expected. When performing static timing analysis, on-chip variation should be accounted for so that timing closure is robust across these local variations

When performing static timing analysis with on-chip variation, derates may be applied to both the launch clock path and the capture clock path. Both of these paths often share a portion of the clock tree (the common path). Without correction, static timing analysis will double-count pessimism on that shared segment: once in the launch path and again in the capture path. This artificially increases the reported clock skew and makes timing appear worse than it really is.

Common path pessimism removal obviates the double-counted pessimism. It identifies the common portion of the clock tree that exists between the launch and capture flops and subtracts the variation applied to that shared portion so that only the unique (non-overlapping) paths keep their pessimism margins. The result is a more realistic and less pessimistic timing analysis.

Inputs to the initialization process include arc attributes in consideration of rise/fall conditions and unateness, timing exceptions (e.g., multi-cycle and false paths), and start point and end point attributes (e.g., clock arrival times, minimum required times). In static timing analysis, start points are the launching elements of a timing path, such as the output of a flip-flop, an input port, or a latch or other memory element. End points are the capturing elements of a timing path, where a signal must arrive on time. This may be the input of a flip-flop, an output port, or another sequential element, for example. Together, a start point and an end point define the timing path boundaries for static timing analysis.

Unateness characterizes the monotonic relationship between an input signal and an output signal of a logic gate or path. A gate or output is positive unate in an input if increasing the input always causes the output to move in the same direction or remain constant. A gate or output is negative unate in an input if increasing the input always causes the output to move in the opposite direction or remain constant. A gate/output is non-unate in an input if the input-to-output relationship depends on other inputs, such that the direction of movement isn't consistent.

In one embodiment, these initialization inputs may be extracted from a commercial static timing analysis tool such as Synopsys® Primetime®. The initialization process constructs and levelizes a timing graph for parallel arrival time propagation from these inputs, where pins within the same level are processed independently. This levelization process may be carried out by topological sort, for example using a mechanism such as Graph-Tool (a Python library for graph analysis and visualization, built on top of C++).

The process may implement a parametric on-chip variation model, wherein the arrival time at each pin is modeled as a Gaussian distribution characterized by a mean and a standard deviation (std). The mean and standard deviation of these delay distributions are propagated at each timing level based on the variational arc delay attributes extracted for initialization. For an arc j→i with variation attributes arc mean_{j→i} and arc std_{j→i}, the final arrival time at the sink i is calculated as:

$${arrival\_mean}_{i} = {arrival\_mean}_{j} + {arc\_mean}_{j \to i}$$

$${arrival\_std}_{i}^{2} = {arrival\_std}_{j}^{2} + {arc\_std}_{j \to i}^{2}$$

$${arrival}_{i} = {arrival\_mean}_{i} + {N}_{σ} * {arrival\_std}_{i}$$

where N_{σ} controls the level of pessimism. The arrival time at the pin i denotes the corner value of its propagated distribution. In one implementation, N_{σ} may be set to 3.0 in alignment with PrimeTime.

Conventional static timing analysis mechanisms attempt to manage common path pessimism removal through branch-and-bound techniques for search-space pruning, block-based algorithms with alternative delay metrics to reduce pessimism, and lowest common ancestor path tracing. However, these methods may incur substantial runtime overhead or accuracy trade-offs. Recent efforts to utilize graphics processing unit (GPU) parallelism for common path pessimism removal path tracing have improved performance but may still fall short of industrial requirements.

The disclosed mechanisms address common path pessimism removal using an efficient GPU-accelerated method that employs Top-K arrival time propagation while ensuring that each arrival distribution is mapped to a particular start point. Priority queues may be established at each pin to track and update the Top-K critical arrival distributions with respect to unique timing start points.

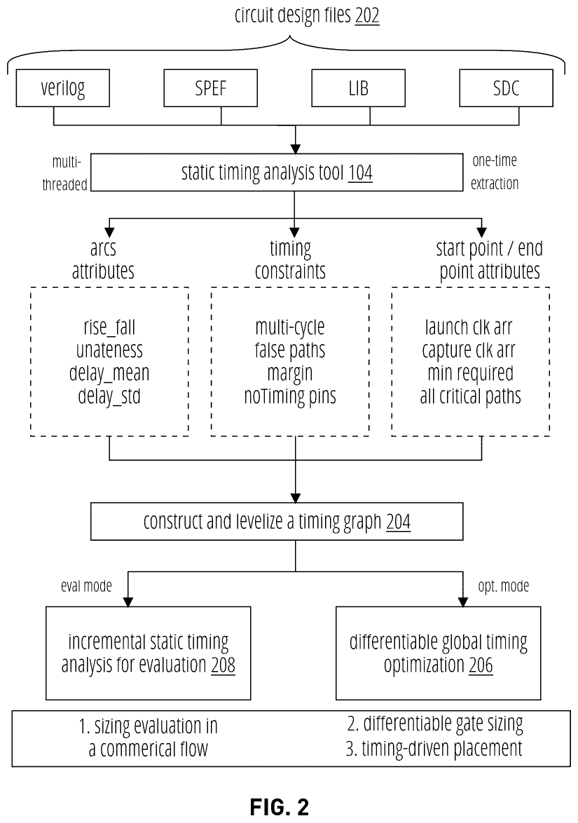

FIG. 2 depicts additional aspects of a circuit configuration process in one embodiment. Circuit design files 202 are processed through the static timing analysis tool 104 to generate timing and other parameters utilized to construct and levelize a timing graph 204 for the circuit 102. The timing graph is utilized to perform differentiable global timing optimization 206 and/or incremental static timing analysis for evaluation 208. The timing graph may be periodically updated during these iterative processes.

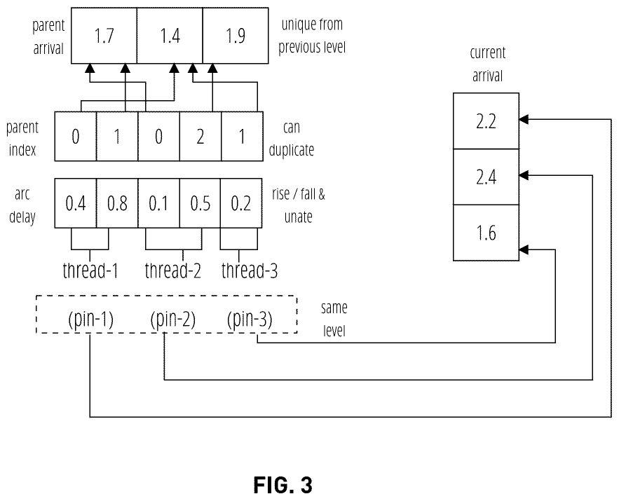

FIG. 3 depicts an example of the utilization of multiple execution threads to perform arrival time propagation and merging, where each pin of a circuit on a same timing level is mapped to a thread.

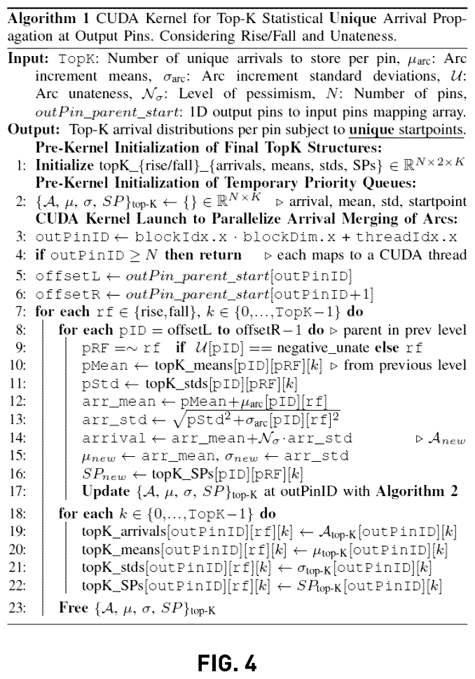

At each timing level, an index array in shared memory maps each thread, representing a pin at the current level, to its parent pins. This mapping enables accurate merging of arrival time distributions across multiple incoming arcs while accounting for rise and fall conditions and unateness constraints. Exemplary logic to implement this process is depicted in FIG. 4.

The process depicted in FIG. 4 focuses kernel processing (e.g., on a GPU) on output pins where multiple arcs converge. For input pins, the use of kernels may be avoided because each input pin is typically connected to a single parent. Thus for input pins, the disclosed mechanisms may apply a vectorized approach (e.g., on a CPU) that is computationally efficient but that avoids the overhead of data transfer to a GPU.

The process determines, in parallel over pins, the Top-K worst-case arrival distributions for both rise and fall at each pin, by merging the Top-K arrivals of its parents with each incoming arc's delay distribution, respecting unateness, and applying a pessimism factor Nu to rank candidates via A=μ+Nu·σ.

In the process of FIG. 4, each thread:
Is assigned to an output pin of the circuit;
Gathers the Top-K arrival distributions for each parent of the pin;
Propagates the mean and standard deviation of arrival distributions through the parent-child arc using:

$${μ}_{out} = {μ}_{in} + {μ}_{a r c} ; and$$

$${σ}_{out} = \sqrt{{σ}_{i n}^{2} + {σ}_{a r c}^{2}} ;$$

Maps rise and fall edges to unateness;
Scores candidate distributions as A=μ+Nuσ; and
Stores the highest-scoring (worst case) unique start point arrivals for rise and fall.

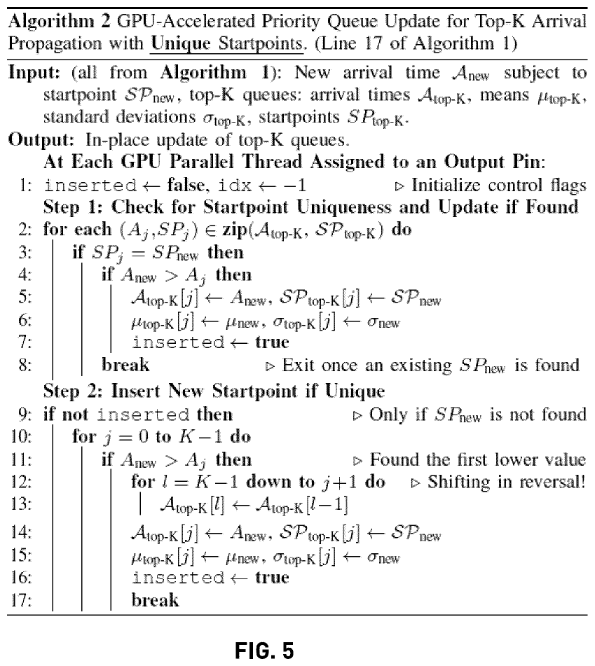

Line 17 of the logic listing in FIG. 4 invokes the exemplary priority queues update logic depicted in FIG. 5 for handling common path pessimism removal. This ensures that each Top-K entry corresponds to a unique start point while dynamically maintaining the Top-K arrival times. If a new start point SP_{new} to process already exists in the queue, its new arrival time A_{new} is compared with the existing value, and the entry is updated if A_{new} is larger. If the new start point SP_{new} is not already in the queue, a check is made to determine if A_{new} exceeds the smallest arrival time in the current list. If so, the new value is inserted in the appropriate queue position to maintain descending order, with entries shifted as needed.

In Algorithm 1 and Algorithm 2, the “greater than” operation identifies the maximum arrival time at a pin from multiple incoming paths. While effective for evaluation, a straightforward greater than comparison introduces non-differentiability, rendering it impractical for optimization. The limitation arises from its exclusivity, propagating only the arrival distribution of the most critical path and blocking gradient flow from other inputs. This approach may be particularly problematic when multiple input paths provide near-critical arrival times, as it disregards opportunities to optimize other sub-critical paths to improve overall timing. To overcome this, the disclosed mechanisms utilize a numerically stable log-sum-exponential (LSE) operator comprising a differentiable approximation of the maximum function. The LSE operator provides smoother gradient distribution across all inputs, enabling more comprehensive optimization. It is defined as:

$$LSE ( {\{ {A}_{i} \}}_{i = 1}^{n} ) = M + τ \cdot log ( {\sum }_{i = I}^{n} exp ( \frac{{A}_{i} - M}{τ} ) ) \qquad Equation l$$

where {Ai} denotes the set of arrival times at a given pin,

$$M = max ( {\{ {A}_{i} \}}_{i = 1}^{n} )$$

ensures numerical stability, and τ>0 is a temperature parameter controlling the degree of smoothness.

As τ→0, the LSE operator converges to the standard maximum operator as:

$${lim}_{τ \to 0} LSE ( {\{ {A}_{1} \}}_{i = 1}^{n} ) = max ( {\{ {A}_{i} \}}_{i = 1}^{n} ) \qquad Equation 2$$

Using the algorithm represented in Equation 1, the gradient of LSE may be computed in a kernel with respect to each arrival time Aᵢ as:

$$\frac{\partial LSE ( {\{ {A}_{i} \}}_{i = 1}^{n}}{\partial {A}_{i}} = \frac{exp ( \frac{{A}_{i} - M}{τ} )}{{\sum }_{j = 1}^{n} exp ( \frac{{A}_{j} - M}{τ} )} \qquad Equation 3$$

which effectively assigns a softmax-like weight to each path. The term exp ((Aᵢ−M)/τ) ensures that paths with larger arrival times receive higher contributions, while smaller paths contribute proportionally less. This algorithmic formulation of a greater than evaluation ensures full differentiability, allowing gradient descent to account for the full timing graph during optimization.

The process depicted in FIG. 5 may be invoked from the process depicted in FIG. 4 to facilitate common path pessimism removal. The process of FIG. 5 maintains sorted Top-K queues of best arrivals per startpoint for each pin. Entries in the queues are updated/replaced in time complexity O(K). The process efficiently matches launch/capture entries by startpoint and enables removal of common-path pessimism statistically using the stored, a to compute a less pessimistic slack.

The process of FIG. 5 maintains, per output pin, a sorted Top-K list of best arrival candidates with uniqueness by startpoint. If a new candidate comes from a startpoint already represented, it updates in place only if it's better (keeps the best per startpoint). If it's from a new startpoint, it is inserted in score-order and the worst (K^{th}+1) entry is evicted by shifting, if needed.

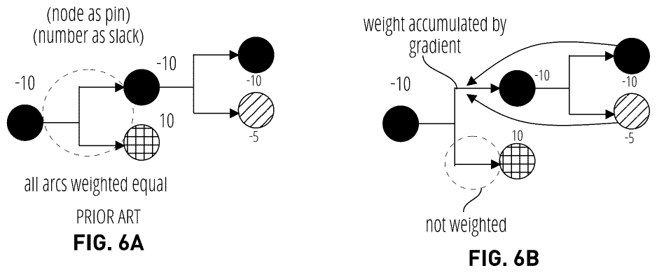

FIG. 6A and FIG. 6B depict, respectively, conventional arc weighting contrasted with arc-based weighting guided by timing gradients. Unlike the conventional approach, weights may assigned to arcs based on their timing gradient contributions to global timing metrics, providing a more fine-grained and accurate optimization than achievable with some conventional approaches. Instead of uniform net weighting, pin-to-pin Manhattan distances weighted by their respective timing gradients are used, enabling more targeted improvements in timing.

Timing gradients may be determined for each arc, reflecting their individual contributions to global timing metrics like total negative slack. Total negative slack is a timing metric used in circuit design for evaluating the timing performance of a digital circuit. It represents the cumulative amount by which the circuit's actual signal propagation delays exceed the required timing constraints, specifically in paths that violate the desired timing.

Total negative slack is calculated by summing the negative slacks across all timing paths that do not meet the required setup time. A higher total negative slack indicates more extensive timing violations, potentially impacting the performance and reliability of the circuit. Reducing total negative slack is often a critical goal during the design optimization phase to ensure timing closure.

Unlike conventional approaches, the Manhattan distances between driver and sink pins are weighted based on timing gradients and dynamically scale the timing objective relative to wirelength and density objectives by aligning their gradient magnitudes.

Unlike prior approaches that use static net weights, the timing-driven placement mechanism depicted in FIG. 6B may apply differentiable timing analysis, enabling precise gradient computation. In contrast, prior methods use non-differentiable timing propagation, which restricts optimization flexibility. Also unlike conventional approaches, the timing-driven placement of FIG. 6B may not rely solely on potentially slower and less efficient CPU-based timing engines.

Instead of relying on “slack values”, the weighting strategy reflects each arc's contribution (i.e., gradient) to global timing metrics such as total negative slack. Pin-to-pin Manhattan distances are weighted by their respective timing gradients.

Specifically, at each placement iteration, given:
the current pin locations

$$P = {\{ ( {x}_{i} , {y}_{i} ) \}}_{i = 1}^{N} ;$$

the critical timing arc indices

$$I = {\{ ( {f}_{k} , {t}_{k} ) \}}_{k = 1}^{M} ,$$

where fₖ and tₖ denote the indices of the driver and sink of the k-th arc; and
the associated timing gradients

$$G = {\{ {g}_{k} \}}_{k = 1}^{M} ,$$

the timing objective may be configured as:

$${L}_{timing} = {λ}_{R C} \cdot {\sum }_{k = 1}^{M} ( \vert {x}_{{f}_{k}} - {x}_{{t}_{k}} \vert + \vert {y}_{{f}_{k}} - {y}_{{t}_{k}} \vert ) \cdot {g}_{k} \qquad Equation 4$$

where λ_{RC} denotes the global time constant scaling that reflects the RC delay per wirelength.

To integrate timing-awareness into the global placement process, the timing objecting L_{timing} may be combined with the default wirelength L_{WL} and density L_{DEN} objectives as follows:

$$L = {\underbrace{{L}_{W L} + {λ}_{1} {L}_{d e n}}}_{default objective} + {\underbrace{{λ}_{2} {L}_{timing}}}_{timing objective} , s . t . {λ}_{2} = \frac{‖ ∇ ( {L}_{W L} + {λ}_{1} {L}_{d e n} ) ‖}{‖ ∇ {L}_{timing} ‖} \qquad Equation 5$$

where λ₁ is the default density scaling factor, and λ₂ dynamically adjusts the contribution of L_{timing} relative to the default wirelength and density objectives by aligning the Euclidean norm ∥⋅∥ of their gradients.

For computational efficiency, the timing graph may be refreshed with a static timing analysis tool such as OpenTimer after each set (e.g., 15) of iterations while reusing last-computed timing gradients for the remaining (e.g., 14) iterations of the set. This approach helps ensure accurate timing analysis without incurring excessive computational overhead.

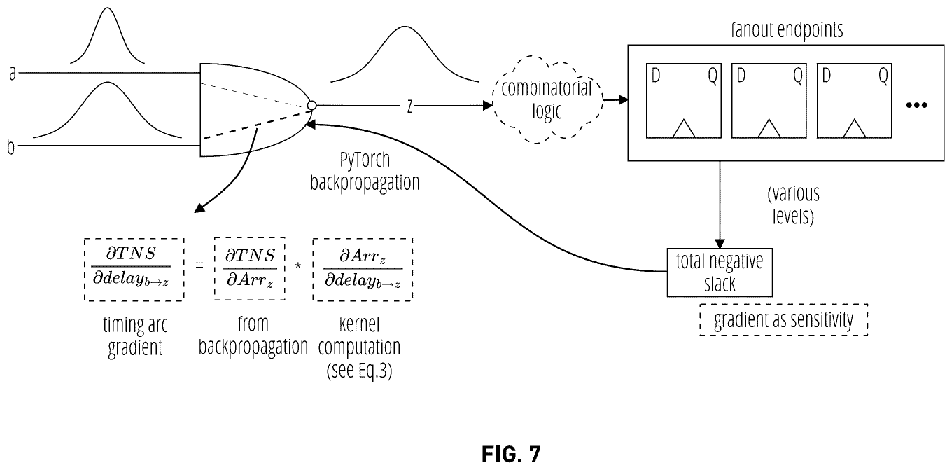

FIG. 7 depicts the determination of timing gradients in one embodiment. For either cell arc or net arc, a timing gradient is determined that quantifies its contribution to global timing metrics such as worst negative slack and total negative slack (TNS). The timing gradient of each arc accounts for rise, fall, and unateness conditions. The timing gradient quantifies an arc's contribution to global timing metrics such as worst negative slack and total negative slack, which enables targeted and fine-grained physical design optimization.

Analogizing to machine learning models, each pin in the timing graph corresponds to a neuron, and the pin-to-pin arc delays correspond to weights. The disclosed mechanisms compute timing metrics in a differentiable manner similar to how forward propagation in a machine learning model operates a differentiable loss function to update neuron weights.

In one embodiment, the disclosed mechanisms utilize PyTorch's C++/CUDA extensions to enable auto-differentiation for efficient gradient backpropagation. This structure delegates complicated global gradient flow to the PyTorch framework while focusing the process logic on gradient computations applying a custom backward CUDA kernel at each timing level.

Utilizing the algorithm in Equation 3, the backward kernel determines the gradient of merged arrival times (Arr_{z}) at a destination pin in regards to incremental changes in arc delays (e.g., ∂Arr_{z}/∂delay_{b→z}). The timing gradient of each arc is subsequently derived by combining this kernel's output with the backpropagated gradient contributions from the previous fanout level.

The mechanisms disclosed herein may be implemented in and/or by computing devices utilizing one or more graphic processing unit (GPU) and/or general purpose data processor (e.g., a central processing unit or CPU). For example, a computer system or data center may comprise a memory configured with machine-readable instructions (e.g., CUDA instructions) that, when applied to one or more graphics processing unit, may configure one or more computer systems to carry out the processes disclosed herein. Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

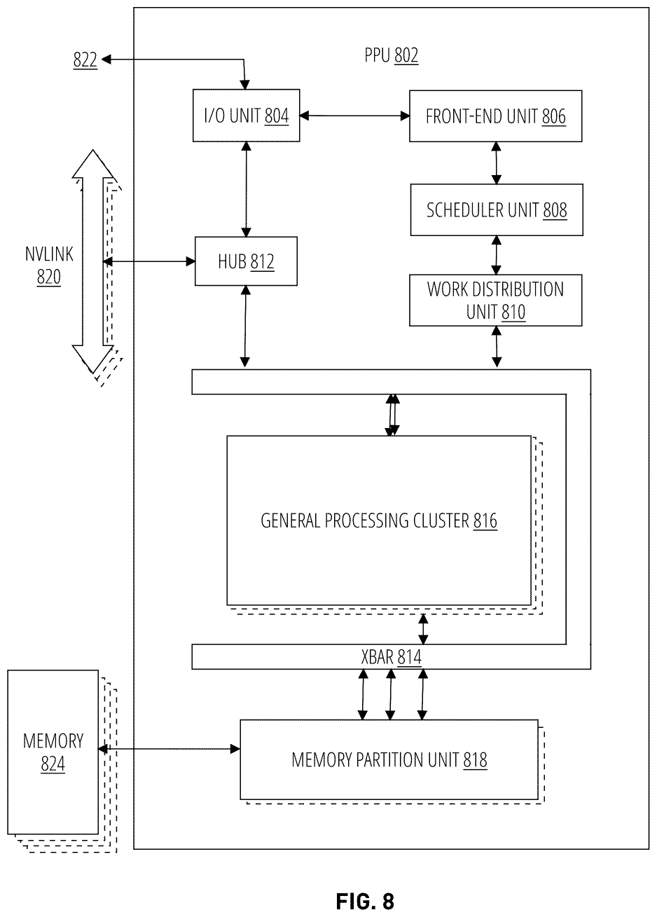

FIG. 8 depicts a parallel processing unit 802, in accordance with an embodiment. In an embodiment, the parallel processing unit 802 is a multi-threaded processor that is implemented on one or more integrated circuit devices. The parallel processing unit 802 is a latency hiding architecture designed to process many threads in parallel. A thread (e.g., a thread of execution) is an instantiation of a set of instructions configured to be executed by the parallel processing unit 802. In an embodiment, the parallel processing unit 802 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 802 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 802 modules may be configured to accelerate thousands of High Performance Computing (HPC), data center, and machine learning applications. The parallel processing unit 802 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 8, the parallel processing unit 802 includes an I/O unit 804, a front-end unit 806, a scheduler unit 808, a work distribution unit 810, a hub 812, a crossbar 814, one or more general processing cluster 816 modules, and one or more memory partition unit 818 modules. The parallel processing unit 802 may be connected to a host processor or other parallel processing unit 802 modules via one or more high-speed NVLink 820 interconnects. The parallel processing unit 802 may be connected to a host processor or other peripheral devices via an interconnect 822. The parallel processing unit 802 may also be connected to a local memory comprising a number of memory 824 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 824 may comprise logic to configure the parallel processing unit 802 to carry out aspects of the techniques disclosed herein.

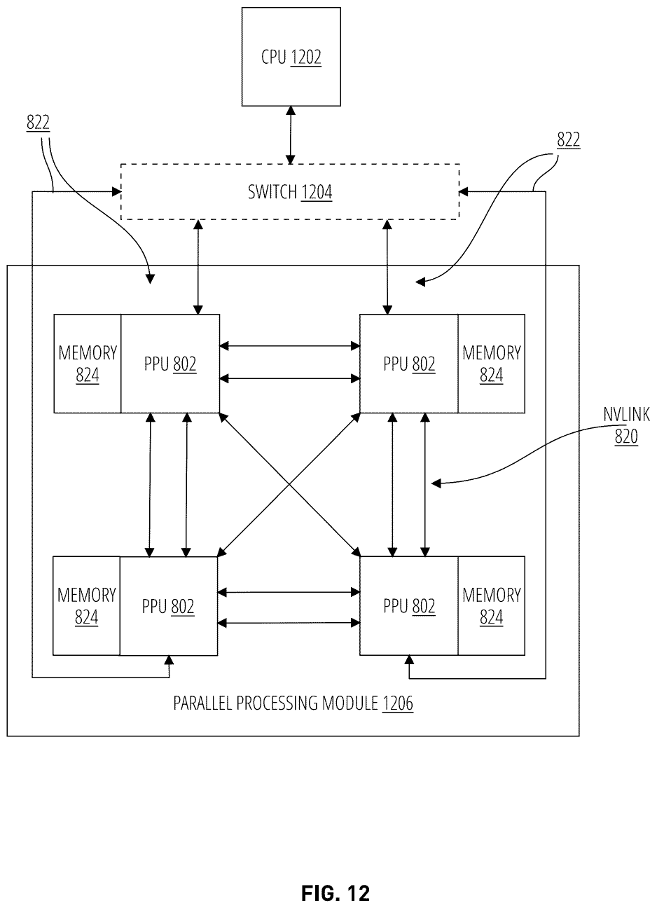

The NVLink 820 interconnect enables systems to scale and include one or more parallel processing unit 802 modules combined with one or more CPUs, supports cache coherence between the parallel processing unit 802 modules and CPUs, and CPU mastering. Data and/or commands may be transmitted by the NVLink 820 through the hub 812 to/from other units of the parallel processing unit 802 such as one or more copy engines, a video encoder, a video decoder, a power management unit, etc. (not explicitly shown). The NVLink 820 is described in more detail in conjunction with FIG. 12.

The I/O unit 804 is configured to transmit and receive communications (e.g., commands, data, etc.) from a host processor (not shown) over the interconnect 822. The I/O unit 804 may communicate with the host processor directly via the interconnect 822 or through one or more intermediate devices such as a memory bridge. In an embodiment, the I/O unit 804 may communicate with one or more other processors, such as one or more parallel processing unit 802 modules via the interconnect 822. In an embodiment, the I/O unit 804 implements a Peripheral Component Interconnect Express (PCIe) interface for communications over a PCIe bus and the interconnect 822 is a PCIe bus. In alternative embodiments, the I/O unit 804 may implement other types of well-known interfaces for communicating with external devices.

The I/O unit 804 decodes packets received via the interconnect 822. In an embodiment, the packets represent commands configured to cause the parallel processing unit 802 to perform various operations. The I/O unit 804 transmits the decoded commands to various other units of the parallel processing unit 802 as the commands may specify. For example, some commands may be transmitted to the front-end unit 806. Other commands may be transmitted to the hub 812 or other units of the parallel processing unit 802 such as one or more copy engines, a video encoder, a video decoder, a power management unit, etc. (not explicitly shown). In other words, the I/O unit 804 is configured to route communications between and among the various logical units of the parallel processing unit 802.

In an embodiment, a program executed by the host processor encodes a command stream in a buffer that provides workloads to the parallel processing unit 802 for processing. A workload may comprise several instructions and data to be processed by those instructions. The buffer is a region in a memory that is accessible (e.g., read/write) by both the host processor and the parallel processing unit 802. For example, the I/O unit 804 may be configured to access the buffer in a system memory connected to the interconnect 822 via memory requests transmitted over the interconnect 822. In an embodiment, the host processor writes the command stream to the buffer and then transmits a pointer to the start of the command stream to the parallel processing unit 802. The front-end unit 806 receives pointers to one or more command streams. The front-end unit 806 manages the one or more streams, reading commands from the streams and forwarding commands to the various units of the parallel processing unit 802.

The front-end unit 806 is coupled to a scheduler unit 808 that configures the various general processing cluster 816 modules to process tasks defined by the one or more streams. The scheduler unit 808 is configured to track state information related to the various tasks managed by the scheduler unit 808. The state may indicate which general processing cluster 816 a task is assigned to, whether the task is active or inactive, a priority level associated with the task, and so forth. The scheduler unit 808 manages the execution of a plurality of tasks on the one or more general processing cluster 816 modules.

The scheduler unit 808 is coupled to a work distribution unit 810 that is configured to dispatch tasks for execution on the general processing cluster 816 modules. The work distribution unit 810 may track a number of scheduled tasks received from the scheduler unit 808. In an embodiment, the work distribution unit 810 manages a pending task pool and an active task pool for each of the general processing cluster 816 modules. The pending task pool may comprise a number of slots (e.g., 32 slots) that contain tasks assigned to be processed by a particular general processing cluster 816. The active task pool may comprise a number of slots (e.g., 4 slots) for tasks that are actively being processed by the general processing cluster 816 modules. As a general processing cluster 816 finishes the execution of a task, that task is evicted from the active task pool for the general processing cluster 816 and one of the other tasks from the pending task pool is selected and scheduled for execution on the general processing cluster 816. If an active task has been idle on the general processing cluster 816, such as while waiting for a data dependency to be resolved, then the active task may be evicted from the general processing cluster 816 and returned to the pending task pool while another task in the pending task pool is selected and scheduled for execution on the general processing cluster 816.

The work distribution unit 810 communicates with the one or more general processing cluster 816 modules via crossbar 814. The crossbar 814 is an interconnect network that couples many of the units of the parallel processing unit 802 to other units of the parallel processing unit 802. For example, the crossbar 814 may be configured to couple the work distribution unit 810 to a particular general processing cluster 816. Although not shown explicitly, one or more other units of the parallel processing unit 802 may also be connected to the crossbar 814 via the hub 812.

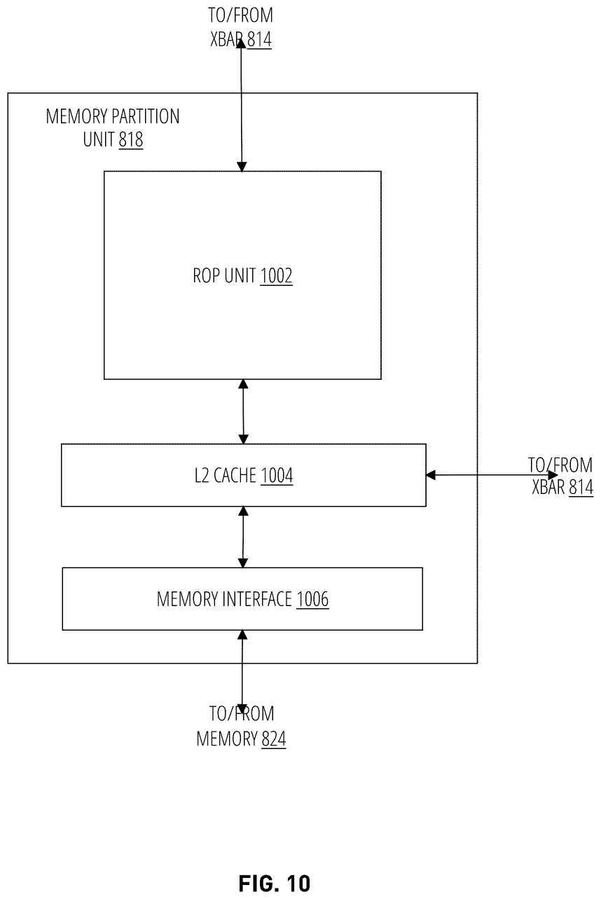

The tasks are managed by the scheduler unit 808 and dispatched to a general processing cluster 816 by the work distribution unit 810. The general processing cluster 816 is configured to process the task and generate results. The results may be consumed by other tasks within the general processing cluster 816, routed to a different general processing cluster 816 via the crossbar 814, or stored in the memory 824. The results can be written to the memory 824 via the memory partition unit 818 modules, which implement a memory interface for reading and writing data to/from the memory 824. The results can be transmitted to another parallel processing unit 802 or CPU via the NVLink 820. In an embodiment, the parallel processing unit 802 includes a number U of memory partition unit 818 modules that is equal to the number of separate and distinct memory 824 devices coupled to the parallel processing unit 802. A memory partition unit 818 will be described in more detail below in conjunction with FIG. 10.

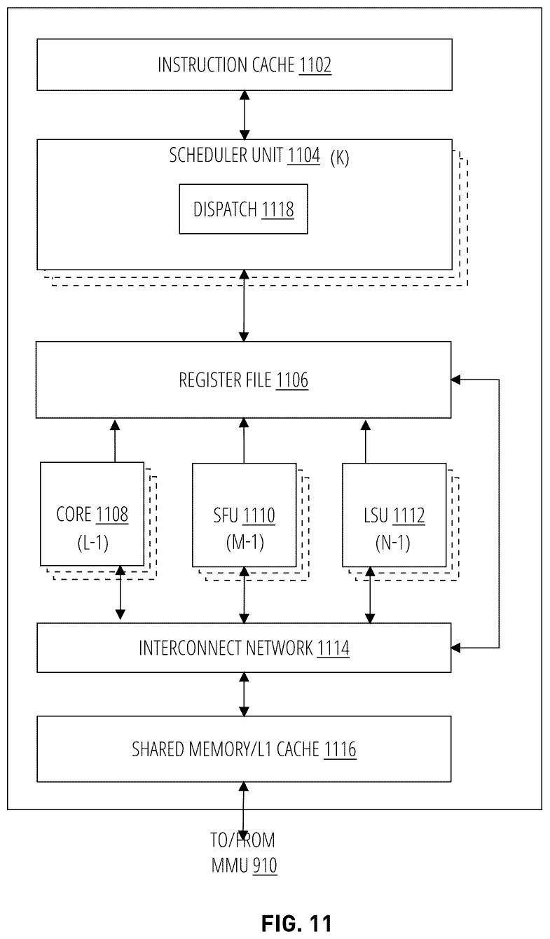

In an embodiment, a host processor executes a driver kernel that implements an application programming interface (API) that enables one or more applications executing on the host processor to schedule operations for execution on the parallel processing unit 802. In an embodiment, multiple compute applications are simultaneously executed by the parallel processing unit 802 and the parallel processing unit 802 provides isolation, quality of service (QoS), and independent address spaces for the multiple compute applications. An application may generate instructions (e.g., API calls) that cause the driver kernel to generate one or more tasks for execution by the parallel processing unit 802. The driver kernel outputs tasks to one or more streams being processed by the parallel processing unit 802. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 11.

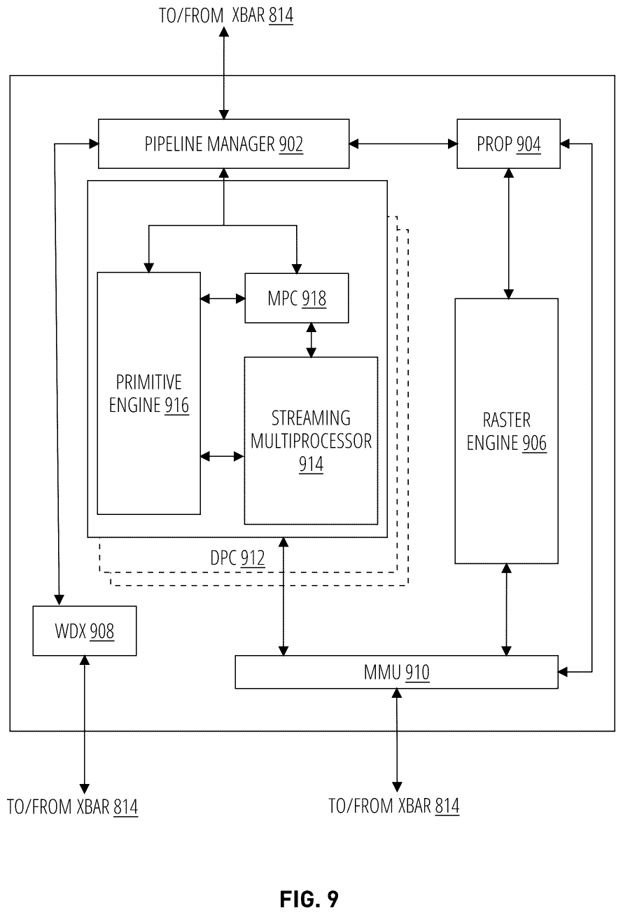

FIG. 9 depicts a general processing cluster 816 of the parallel processing unit 802 of FIG. 8, in accordance with an embodiment. As shown in FIG. 9, each general processing cluster 816 includes a number of hardware units for processing tasks. In an embodiment, each general processing cluster 816 includes a pipeline manager 902, a pre-raster operations unit 904, a raster engine 906, a work distribution crossbar 908, a memory management unit 910, and one or more data processing cluster 912. It will be appreciated that the general processing cluster 816 of FIG. 9 may include other hardware units in lieu of or in addition to the units shown in FIG. 9.

In an embodiment, the operation of the general processing cluster 816 is controlled by the pipeline manager 902. The pipeline manager 902 manages the configuration of the one or more data processing cluster 912 modules for processing tasks allocated to the general processing cluster 816. In an embodiment, the pipeline manager 902 may configure at least one of the one or more data processing cluster 912 modules to implement at least a portion of a graphics rendering pipeline. For example, a data processing cluster 912 may be configured to execute a vertex shader program on the programmable streaming multiprocessor 914. The pipeline manager 902 may also be configured to route packets received from the work distribution unit 810 to the appropriate logical units within the general processing cluster 816. For example, some packets may be routed to fixed function hardware units in the pre-raster operations unit 904 and/or raster engine 906 while other packets may be routed to the data processing cluster 912 modules for processing by the primitive engine 916 or the streaming multiprocessor 914. In an embodiment, the pipeline manager 902 may configure at least one of the one or more data processing cluster 912 modules to implement a neural network model and/or a computing pipeline.

The pre-raster operations unit 904 is configured to route data generated by the raster engine 906 and the data processing cluster 912 modules to a Raster Operations (ROP) unit, described in more detail in conjunction with FIG. 10. The pre-raster operations unit 904 may also be configured to perform optimizations for color blending, organize pixel data, perform address translations, and the like.

The raster engine 906 includes a number of fixed function hardware units configured to perform various raster operations. In an embodiment, the raster engine 906 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 906 comprises fragments to be processed, for example, by a fragment shader implemented within a data processing cluster 912.

Each data processing cluster 912 included in the general processing cluster 816 includes an M-pipe controller 918, a primitive engine 916, and one or more streaming multiprocessor 914 modules. The M-pipe controller 918 controls the operation of the data processing cluster 912, routing packets received from the pipeline manager 902 to the appropriate units in the data processing cluster 912. For example, packets associated with a vertex may be routed to the primitive engine 916, which is configured to fetch vertex attributes associated with the vertex from the memory 824. In contrast, packets associated with a shader program may be transmitted to the streaming multiprocessor 914.

The streaming multiprocessor 914 comprises a programmable streaming processor that is configured to process tasks represented by a number of threads. Each streaming multiprocessor 914 is multi-threaded and configured to execute a plurality of threads (e.g., 32 threads) from a particular group of threads concurrently. In an embodiment, the streaming multiprocessor 914 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 914 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 914 will be described in more detail below in conjunction with FIG. 11.

The memory management unit 910 provides an interface between the general processing cluster 816 and the memory partition unit 818. The memory management unit 910 may provide translation of virtual addresses into physical addresses, memory protection, and arbitration of memory requests. In an embodiment, the memory management unit 910 provides one or more translation lookaside buffers (TLBs) for performing translation of virtual addresses into physical addresses in the memory 824.

FIG. 10 depicts a memory partition unit 818 of the parallel processing unit 802 of FIG. 8, in accordance with an embodiment. As shown in FIG. 10, the memory partition unit 818 includes a raster operations unit 1002, a level two cache 1004, and a memory interface 1006. The memory interface 1006 is coupled to the memory 824. Memory interface 1006 may implement 32, 64, 128, 1024-bit data buses, or the like, for high-speed data transfer. In an embodiment, the parallel processing unit 802 incorporates U memory interface 1006 modules, one memory interface 1006 per pair of memory partition unit 818 modules, where each pair of memory partition unit 818 modules is connected to a corresponding memory 824 device. For example, parallel processing unit 802 may be connected to up to Y memory 824 devices, such as high bandwidth memory stacks or graphics double-data-rate, version 5, synchronous dynamic random access memory, or other types of persistent storage.

In an embodiment, the memory interface 1006 implements an HBM2 memory interface and Y equals half U. In an embodiment, the HBM2 memory stacks are located on the same physical package as the parallel processing unit 802, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 824 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 802 modules process very large datasets and/or run applications for extended periods.

In an embodiment, the parallel processing unit 802 implements a multi-level memory hierarchy. In an embodiment, the memory partition unit 818 supports a unified memory to provide a single unified virtual address space for CPU and parallel processing unit 802 memory, enabling data sharing between virtual memory systems. In an embodiment the frequency of accesses by a parallel processing unit 802 to memory located on other processors is traced to ensure that memory pages are moved to the physical memory of the parallel processing unit 802 that is accessing the pages more frequently. In an embodiment, the NVLink 820 supports address translation services allowing the parallel processing unit 802 to directly access a CPU's page tables and providing full access to CPU memory by the parallel processing unit 802.

In an embodiment, copy engines transfer data between multiple parallel processing unit 802 modules or between parallel processing unit 802 modules and CPUs. The copy engines can generate page faults for addresses that are not mapped into the page tables. The memory partition unit 818 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 824 or other system memory may be fetched by the memory partition unit 818 and stored in the level two cache 1004, which is located on-chip and is shared between the various general processing cluster 816 modules. As shown, each memory partition unit 818 includes a portion of the level two cache 1004 associated with a corresponding memory 824 device. Lower level caches may then be implemented in various units within the general processing cluster 816 modules. For example, each of the streaming multiprocessor 914 modules may implement an L1 cache. The L1 cache is private memory that is dedicated to a particular streaming multiprocessor 914. Data from the level two cache 1004 may be fetched and stored in each of the L1 caches for processing in the functional units of the streaming multiprocessor 914 modules. The level two cache 1004 is coupled to the memory interface 1006 and the crossbar 814.

The raster operations unit 1002 performs graphics raster operations related to pixel color, such as color compression, pixel blending, and the like. The raster operations unit 1002 also implements depth testing in conjunction with the raster engine 906, receiving a depth for a sample location associated with a pixel fragment from the culling engine of the raster engine 906. The depth is tested against a corresponding depth in a depth buffer for a sample location associated with the fragment. If the fragment passes the depth test for the sample location, then the raster operations unit 1002 updates the depth buffer and transmits a result of the depth test to the raster engine 906. It will be appreciated that the number of partition memory partition unit 818 modules may be different than the number of general processing cluster 816 modules and, therefore, each raster operations unit 1002 may be coupled to each of the general processing cluster 816 modules. The raster operations unit 1002 tracks packets received from the different general processing cluster 816 modules and determines which general processing cluster 1 that a result generated by the raster operations unit 1002 is routed to through the crossbar 814. Although the raster operations unit 1002 is included within the memory partition unit 818 in FIG. 10, in other embodiment, the raster operations unit 1002 may be outside of the memory partition unit 818. For example, the raster operations unit 1002 may reside in the general processing cluster 816 or another unit.

FIG. 11 illustrates the streaming multiprocessor 914 of FIG. 9, in accordance with an embodiment. As shown in FIG. 11, the streaming multiprocessor 914 includes an instruction cache 1102, one or more scheduler unit 1104 modules (e.g., such as scheduler unit 808), a register file 1106, one or more processing core 1108 modules, one or more special function unit 1110 modules, one or more load/store unit 1112 modules, an interconnect network 1114, and a shared memory/L1 cache 1116.

As described above, the work distribution unit 810 dispatches tasks for execution on the general processing cluster 816 modules of the parallel processing unit 802. The tasks are allocated to a particular data processing cluster 912 within a general processing cluster 816 and, if the task is associated with a shader program, the task may be allocated to a streaming multiprocessor 914. The scheduler unit 808 receives the tasks from the work distribution unit 810 and manages instruction scheduling for one or more thread blocks assigned to the streaming multiprocessor 914. The scheduler unit 1104 schedules thread blocks for execution as warps of parallel threads, where each thread block is allocated at least one warp. In an embodiment, each warp executes 32 threads. The scheduler unit 1104 may manage a plurality of different thread blocks, allocating the warps to the different thread blocks and then dispatching instructions from the plurality of different cooperative groups to the various functional units (e.g., core 1108 modules, special function unit 1110 modules, and load/store unit 1112 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1118 unit is configured within the scheduler unit 1104 to transmit instructions to one or more of the functional units. In one embodiment, the scheduler unit 1104 includes two dispatch 1118 units that enable two different instructions from the same warp to be dispatched during each clock cycle. In alternative embodiments, each scheduler unit 1104 may include a single dispatch 1118 unit or additional dispatch 1118 units.

Each streaming multiprocessor 914 includes a register file 1106 that provides a set of registers for the functional units of the streaming multiprocessor 914. In an embodiment, the register file 1106 is divided between each of the functional units such that each functional unit is allocated a dedicated portion of the register file 1106. In another embodiment, the register file 1106 is divided between the different warps being executed by the streaming multiprocessor 914. The register file 1106 provides temporary storage for operands connected to the data paths of the functional units.

Each streaming multiprocessor 914 comprises L processing core 1108 modules. In an embodiment, the streaming multiprocessor 914 includes a large number (e.g., 128, etc.) of distinct processing core 1108 modules. Each core 1108 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1108 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1108 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 914 also comprises M special function unit 1110 modules that perform special functions (e.g., attribute evaluation, reciprocal square root, and the like). In an embodiment, the special function unit 1110 modules may include a tree traversal unit configured to traverse a hierarchical tree data structure. In an embodiment, the special function unit 1110 modules may include texture unit configured to perform texture map filtering operations. In an embodiment, the texture units are configured to load texture maps (e.g., a 2D array of texels) from the memory 824 and sample the texture maps to produce sampled texture values for use in shader programs executed by the streaming multiprocessor 914. In an embodiment, the texture maps are stored in the shared memory/L1 cache 1116. The texture units implement texture operations such as filtering operations using mip-maps (e.g., texture maps of varying levels of detail). In an embodiment, each streaming multiprocessor 914 includes two texture units.

Each streaming multiprocessor 914 also comprises N load/store unit 1112 modules that implement load and store operations between the shared memory/L1 cache 1116 and the register file 1106. Each streaming multiprocessor 914 includes an interconnect network 1114 that connects each of the functional units to the register file 1106 and the load/store unit 1112 to the register file 1106 and shared memory/L1 cache 1116. In an embodiment, the interconnect network 1114 is a crossbar that can be configured to connect any of the functional units to any of the registers in the register file 1106 and connect the load/store unit 1112 modules to the register file 1106 and memory locations in shared memory/L1 cache 1116.

The shared memory/L1 cache 1116 is an array of on-chip memory that allows for data storage and communication between the streaming multiprocessor 914 and the primitive engine 916 and between threads in the streaming multiprocessor 914. In an embodiment, the shared memory/L1 cache 1116 comprises 128 KB of storage capacity and is in the path from the streaming multiprocessor 914 to the memory partition unit 818. The shared memory/L1 cache 1116 can be used to cache reads and writes. One or more of the shared memory/L1 cache 1116, level two cache 1004, and memory 824 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1116 enables the shared memory/L1 cache 1116 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 8, are bypassed, creating a much simpler programming model. In the general purpose parallel computation configuration, the work distribution unit 810 assigns and distributes blocks of threads directly to the data processing cluster 912 modules. The threads in a block execute the same program, using a unique thread ID in the calculation to ensure each thread generates unique results, using the streaming multiprocessor 914 to execute the program and perform calculations, shared memory/L1 cache 1116 to communicate between threads, and the load/store unit 1112 to read and write global memory through the shared memory/L1 cache 1116 and the memory partition unit 818. When configured for general purpose parallel computation, the streaming multiprocessor 914 can also write commands that the scheduler unit 808 can use to launch new work on the data processing cluster 912 modules.

The parallel processing unit 802 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 802 is embodied on a single semiconductor substrate. In another embodiment, the parallel processing unit 802 is included in a system-on-a-chip (SoC) along with one or more other devices such as additional parallel processing unit 802 modules, the memory 824, a reduced instruction set computer (RISC) CPU, a memory management unit (MMU), a digital-to-analog converter (DAC), and the like.

In an embodiment, the parallel processing unit 802 may be included on a graphics card that includes one or more memory devices. The graphics card may be configured to interface with a PCIe slot on a motherboard of a desktop computer. In yet another embodiment, the parallel processing unit 802 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 12 is a conceptual diagram of a processing system implemented using the parallel processing unit 802 of FIG. 8, in accordance with an embodiment. The processing system includes a central processing unit 1202, a switch 1204, and multiple parallel processing unit 802 modules each and respective memory 824 modules. The switch 1204 is depicted with dashed lines, indicating that it is optional in some embodiments.

The NVLink 820 provides high-speed communication links between each of the parallel processing unit 802 modules. Although a particular number of NVLink 820 and interconnect 822 connections are illustrated in FIG. 12, the number of connections to each parallel processing unit 802 and the central processing unit 1202 may vary. The switch 1204 interfaces between the interconnect 822 and the central processing unit 1202. The parallel processing unit 802 modules, memory 824 modules, and NVLink 820 connections may be situated on a single semiconductor platform to form a parallel processing module 1206. In an embodiment, the switch 1204 supports two or more protocols to interface between various different connections and/or links.

In another embodiment (not shown), the NVLink 820 provides one or more high-speed communication links between each of the parallel processing unit modules (parallel processing unit 802, parallel processing unit 802, parallel processing unit 802, and parallel processing unit 802) and the central processing unit 1202 and the switch 1204 (when present) interfaces between the interconnect 822 and each of the parallel processing unit modules. The parallel processing unit modules, memory 824 modules, and interconnect 822 may be situated on a single semiconductor platform to form a parallel processing module 1206. In yet another embodiment (not shown), the interconnect 822 provides one or more communication links between each of the parallel processing unit modules and the central processing unit 1202 and the switch 1204 interfaces between each of the parallel processing unit modules using the NVLink 820 to provide one or more high-speed communication links between the parallel processing unit modules. In another embodiment (not shown), the NVLink 820 provides one or more high-speed communication links between the parallel processing unit modules and the central processing unit 1202 through the switch 1204. In yet another embodiment (not shown), the interconnect 822 provides one or more communication links between each of the parallel processing unit modules directly. One or more of the NVLink 820 high-speed communication links may be implemented as a physical NVLink interconnect or either an on-chip or on-die interconnect using the same protocol as the NVLink 820.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1206 may be implemented as a circuit board substrate and each of the parallel processing unit modules and/or memory 824 modules may be packaged devices. In an embodiment, the central processing unit 1202, switch 1204, and the parallel processing module 1206 are situated on a single semiconductor platform.

In an embodiment, each parallel processing unit module includes six NVLink 820 interfaces (as shown in FIG. 12, five NVLink 820 interfaces are included for each parallel processing unit module). The NVLink 820 may be operated exclusively for PPU-to-PPU communication as shown in FIG. 12, or some combination of PPU-to-PPU and PPU-to-CPU, when the central processing unit 1202 also includes one or more NVLink 820 interfaces.

In an embodiment, the NVLink 820 allows direct load/store/atomic access from the central processing unit 1202 to each parallel processing unit module's memory 824. In an embodiment, the NVLink 820 supports coherency operations, allowing data read from the memory 824 modules to be stored in the cache hierarchy of the central processing unit 1202, reducing cache access latency for the central processing unit 1202. In an embodiment, the NVLink 820 includes support for Address Translation Services (ATS), enabling the parallel processing unit module to directly access page tables within the central processing unit 1202. One or more of the NVLink 820 may also be configured to operate in a low-power mode.

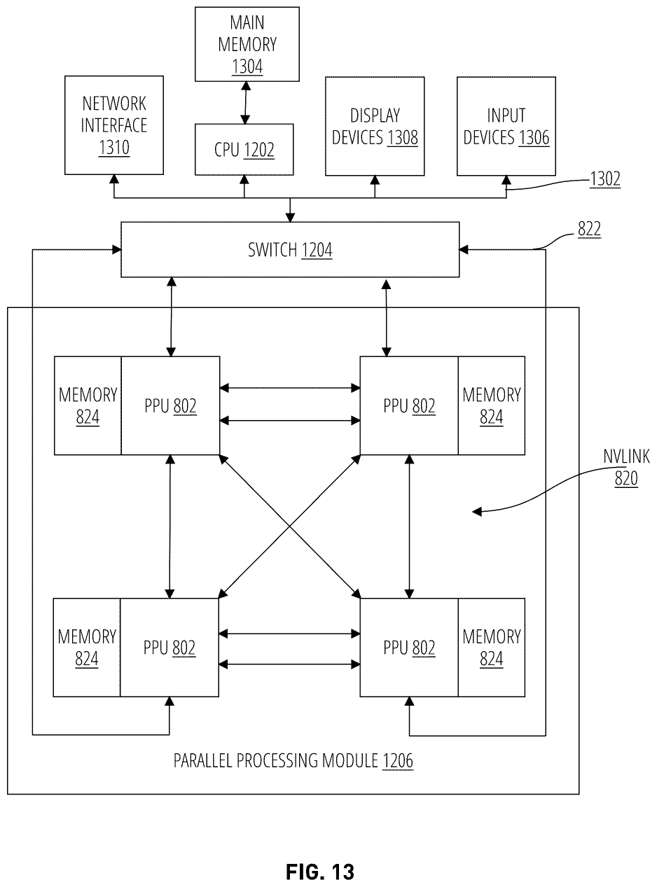

FIG. 13 depicts an exemplary processing system in which the various architecture and/or functionality of the various previous embodiments may be implemented. As shown, an exemplary processing system is provided including at least one central processing unit 1202 that is connected to a communications bus 1302. The communication communications bus 1302 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1304. Control logic (software) and data are stored in the main memory 1304 which may take the form of random access memory (RAM).

The exemplary processing system also includes input devices 1306, the parallel processing module 1206, and display devices 1308, e.g. a conventional CRT (cathode ray tube), LCD (liquid crystal display), LED (light emitting diode), plasma display or the like. User input may be received from the input devices 1306, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, Wide Area Network (WAN) such as the Internet, peer-to-peer network, cable network, or the like) through a network interface 1310 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1304 and/or the secondary storage. Such computer programs, when executed, enable the exemplary processing system to perform various functions. The main memory 1304, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

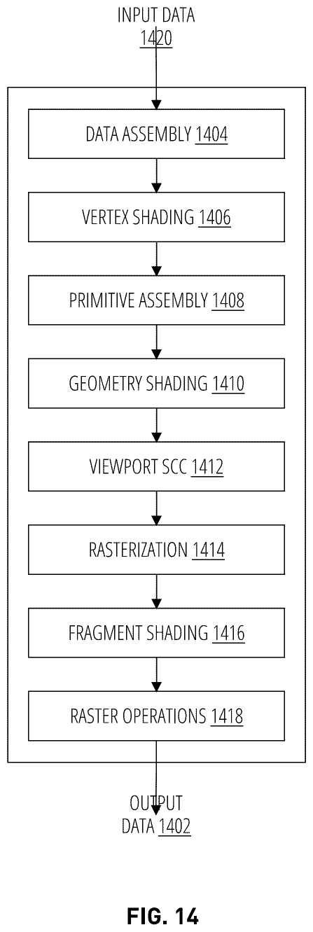

FIG. 14 is a conceptual diagram of a graphics processing pipeline implemented by the parallel processing unit 802 of FIG. 8, in accordance with an embodiment. In an embodiment, the parallel processing unit 802 comprises a graphics processing unit (GPU). The parallel processing unit 802 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The parallel processing unit 802 can be configured to process the graphics primitives to generate a frame buffer (e.g., pixel data for each of the pixels of the display).

An application writes model data for a scene (e.g., a collection of vertices and attributes) to a memory such as a system memory or memory 824. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the streaming multiprocessor 914 modules of the parallel processing unit 802 including one or more of a vertex shader, hull shader, domain shader, geometry shader, and a pixel shader. For example, one or more of the streaming multiprocessor 914 modules may be configured to execute a vertex shader program that processes a number of vertices defined by the model data. In an embodiment, the different streaming multiprocessor 914 modules may be configured to execute different shader programs concurrently. For example, a first subset of streaming multiprocessor 914 modules may be configured to execute a vertex shader program while a second subset of streaming multiprocessor 914 modules may be configured to execute a pixel shader program. The first subset of streaming multiprocessor 914 modules processes vertex data to produce processed vertex data and writes the processed vertex data to the level two cache 1004 and/or the memory 824. After the processed vertex data is rasterized (e.g., transformed from three-dimensional data into two-dimensional data in screen space) to produce fragment data, the second subset of streaming multiprocessor 914 modules executes a pixel shader to produce processed fragment data, which is then blended with other processed fragment data and written to the frame buffer in memory 824. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline receives input data 601 that is transmitted from one stage to the next stage of the graphics processing pipeline to generate output data 1402. In an embodiment, the graphics processing pipeline may represent a graphics processing pipeline defined by the OpenGL® API. As an option, the graphics processing pipeline may be implemented in the context of the functionality and architecture of the previous Figures and/or any subsequent Figure(s).

As shown in FIG. 14, the graphics processing pipeline comprises a pipeline architecture that includes a number of stages. The stages include, but are not limited to, a data assembly 1404 stage, a vertex shading 1406 stage, a primitive assembly 1408 stage, a geometry shading 1410 stage, a viewport SCC 1412 stage, a rasterization 1414 stage, a fragment shading 1416 stage, and a raster operations 1418 stage. In an embodiment, the input data 1420 comprises commands that configure the processing units to implement the stages of the graphics processing pipeline and geometric primitives (e.g., points, lines, triangles, quads, triangle strips or fans, etc.) to be processed by the stages. The output data 1402 may comprise pixel data (e.g., color data) that is copied into a frame buffer or other type of surface data structure in a memory.

The data assembly 1404 stage receives the input data 1420 that specifies vertex data for high-order surfaces, primitives, or the like. The data assembly 1404 stage collects the vertex data in a temporary storage or queue, such as by receiving a command from the host processor that includes a pointer to a buffer in memory and reading the vertex data from the buffer. The vertex data is then transmitted to the vertex shading 1406 stage for processing.

The vertex shading 1406 stage processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading 1406 stage may manipulate individual vertex attributes such as position, color, texture coordinates, and the like. In other words, the vertex shading 1406 stage performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading 1406 stage generates transformed vertex data that is transmitted to the primitive assembly 1408 stage.

The primitive assembly 1408 stage collects vertices output by the vertex shading 1406 stage and groups the vertices into geometric primitives for processing by the geometry shading 1410 stage. For example, the primitive assembly 1408 stage may be configured to group every three consecutive vertices as a geometric primitive (e.g., a triangle) for transmission to the geometry shading 1410 stage. In some embodiments, specific vertices may be reused for consecutive geometric primitives (e.g., two consecutive triangles in a triangle strip may share two vertices). The primitive assembly 1408 stage transmits geometric primitives (e.g., a collection of associated vertices) to the geometry shading 1410 stage.

The geometry shading 1410 stage processes geometric primitives by performing a set of operations (e.g., a geometry shader or program) on the geometric primitives. Tessellation operations may generate one or more geometric primitives from each geometric primitive. In other words, the geometry shading 1410 stage may subdivide each geometric primitive into a finer mesh of two or more geometric primitives for processing by the rest of the graphics processing pipeline. The geometry shading 1410 stage transmits geometric primitives to the viewport SCC 1412 stage.

In an embodiment, the graphics processing pipeline may operate within a streaming multiprocessor and the vertex shading 1406 stage, the primitive assembly 1408 stage, the geometry shading 1410 stage, the fragment shading 1416 stage, and/or hardware/software associated therewith, may sequentially perform processing operations. Once the sequential processing operations are complete, in an embodiment, the viewport SCC 1412 stage may utilize the data. In an embodiment, primitive data processed by one or more of the stages in the graphics processing pipeline may be written to a cache (e.g. L1 cache, a vertex cache, etc.). In this case, in an embodiment, the viewport SCC 1412 stage may access the data in the cache. In an embodiment, the viewport SCC 1412 stage and the rasterization 1414 stage are implemented as fixed function circuitry.

The viewport SCC 1412 stage performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization 1414 stage.

The rasterization 1414 stage converts the 3D geometric primitives into 2D fragments (e.g. capable of being utilized for display, etc.). The rasterization 1414 stage may be configured to utilize the vertices of the geometric primitives to setup a set of plane equations from which various attributes can be interpolated. The rasterization 1414 stage may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization 1414 stage generates fragment data (e.g., interpolated vertex attributes associated with a particular sample location for each covered pixel) that are transmitted to the fragment shading 1416 stage.

The fragment shading 1416 stage processes fragment data by performing a set of operations (e.g., a fragment shader or a program) on each of the fragments. The fragment shading 1416 stage may generate pixel data (e.g., color values) for the fragment such as by performing lighting operations or sampling texture maps using interpolated texture coordinates for the fragment. The fragment shading 1416 stage generates pixel data that is transmitted to the raster operations 1418 stage.

The raster operations 1418 stage may perform various operations on the pixel data such as performing alpha tests, stencil tests, and blending the pixel data with other pixel data corresponding to other fragments associated with the pixel. When the raster operations 1418 stage has finished processing the pixel data (e.g., the output data 1402), the pixel data may be written to a render target such as a frame buffer, a color buffer, or the like.

It will be appreciated that one or more additional stages may be included in the graphics processing pipeline in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading 1410 stage). Other types of graphics processing pipelines are contemplated as being within the scope of the present disclosure. Furthermore, any of the stages of the graphics processing pipeline may be implemented by one or more dedicated hardware units within a graphics processor such as parallel processing unit 802. Other stages of the graphics processing pipeline may be implemented by programmable hardware units such as the streaming multiprocessor 914 of the parallel processing unit 802.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the parallel processing unit 802. The API provides an abstraction for a programmer that lets a programmer utilize specialized graphics hardware, such as the parallel processing unit 802, to generate the graphical data without requiring the programmer to utilize the specific instruction set for the parallel processing unit 802. The application may include an API call that is routed to the device driver for the parallel processing unit 802. The device driver interprets the API call and performs various operations to respond to the API call. In some instances, the device driver may perform operations by executing instructions on the CPU. In other instances, the device driver may perform operations, at least in part, by launching operations on the parallel processing unit 802 utilizing an input/output interface between the CPU and the parallel processing unit 802. In an embodiment, the device driver is configured to implement the graphics processing pipeline utilizing the hardware of the parallel processing unit 802.

Various programs may be executed within the parallel processing unit 802 in order to implement the various stages of the graphics processing pipeline. For example, the device driver may launch a kernel on the parallel processing unit 802 to perform the vertex shading 1406 stage on one streaming multiprocessor 914 (or multiple streaming multiprocessor 914 modules). The device driver (or the initial kernel executed by the parallel processing unit 802) may also launch other kernels on the parallel processing unit 802 to perform other stages of the graphics processing pipeline, such as the geometry shading 1410 stage and the fragment shading 1416 stage. In addition, some of the stages of the graphics processing pipeline may be implemented on fixed unit hardware such as a rasterizer or a data assembler implemented within the parallel processing unit 802. It will be appreciated that results from one kernel may be processed by one or more intervening fixed function hardware units before being processed by a subsequent kernel on a streaming multiprocessor 914.

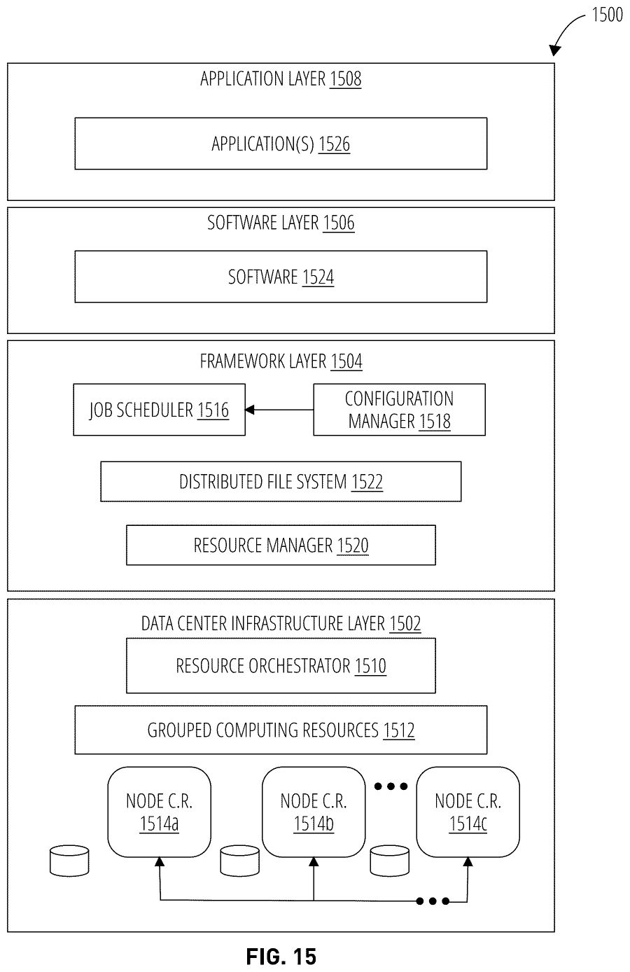

FIG. 15 depicts an exemplary data center 1500, in accordance with at least one embodiment. In at least one embodiment, data center 1500 includes, without limitation, a data center infrastructure layer 1502, a framework layer 1504, a software layer 1506, and an application layer 1508.

In at least one embodiment, as depicted in FIG. 15, data center infrastructure layer 1502 may include a resource orchestrator 1510, grouped computing resources 1512, and node computing resources (node C.R.s) 1514a, 1514b, 1514c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (g, dynamic read-only memory), storage devices (g, solid state or disk drives), network input/output (NW I/O) devices, network switches, virtual machines (VMs), power modules, and cooling modules, etc. In at least one embodiment, one or more node computing resources from among node computing resources 1514a, 1514b, 1514c may be a server having one or more of the above-mentioned computing resources.

In at least one embodiment, grouped computing resources 1512 may include separate groupings of node computing resources housed within one or more racks (not shown), or many racks housed in data centers at various geographical locations (also not shown). Separate groupings of node computing resources within grouped computing resources 1512 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1510 may configure or otherwise control one or more node computing resources 1514a, 1514b, 1514c and/or grouped computing resources 1512. In at least one embodiment, resource orchestrator 1510 may include a software design infrastructure (“SDI”) management entity for data center 1500. In at least one embodiment, resource orchestrator 1510 may include hardware, software, or some combination thereof.

In at least one embodiment, as depicted in FIG. 15, framework layer 1504 includes, without limitation, a job scheduler 1516, a configuration manager 1518, a resource manager 1520, and a distributed file system 1522. In at least one embodiment, framework layer 1504 may include a framework to support software 1524 of software layer 1506 and/or one or more application(s) 1526 of application layer 220. In at least one embodiment, software 1524 or application(s) 1526 may respectively include web-based service software or applications, such as those provided by Amazon Web Services, Google Cloud, and Microsoft Azure. In at least one embodiment, framework layer 1504 may be, but is not limited to, a type of free and open-source software web application framework such as Apache SPARK™ (hereinafter “Spark) that may utilize a distributed file system 1522 for large-scale data processing (g, “big data”). In at least one embodiment, job scheduler 1516 may include a Spark driver to facilitate scheduling of workloads supported by various layers of data center 1500. In at least one embodiment, configuration manager 1518 may be capable of configuring different layers such as software layer 1506 and framework layer 1504, including Spark and distributed file system 1522 for supporting large-scale data processing. In at least one embodiment, resource manager 1520 may be capable of managing clustered or grouped computing resources mapped to or allocated for support of distributed file system 1522 and job scheduler 1516. In at least one embodiment, clustered or grouped computing resources may include grouped computing resources 1512 at data center infrastructure layer 1502. In at least one embodiment, resource manager 1520 may coordinate with resource orchestrator 1510 to manage these mapped or allocated computing resources.

In at least one embodiment, software 1524 included in software layer 1506 may include software used by at least portions of node computing resources 1514a, 1514b, 1514c, grouped computing resources 1512, and/or distributed file system 1522 of framework layer 1504. One or more types of software may include, but are not limited to, Internet web page search software, e-mail virus scan software, database software, and streaming video content software.

In at least one embodiment, application(s) 1526 included in application layer 1508 may include one or more types of applications used by at least portions of node computing resources 1514a, 1514b, 1514c, grouped computing resources 1512, and/or distributed file system 1522 of framework layer 1504. In at least one or more types of applications may include, without limitation, Compute Unified Device Architecture (CUDA) applications, 5G network applications, artificial intelligence applications, data center applications, and/or variations thereof.

In at least one embodiment, any of configuration manager 1518, resource manager 1520, and resource orchestrator 1510 may implement any number and type of self-modifying actions based on any amount and type of data acquired in any technically feasible fashion. In at least one embodiment, self-modifying actions may relieve a data center operator of data center 1500 from making possibly bad configuration decisions and possibly avoiding underutilized and/or poorly performing portions of a data center.

### LISTING OF DRAWING ELEMENTS

102 circuit
104 static timing analysis tool
106 timing propagation
108 slack determination
110 netlist adjustments
112 update arc delays
202 circuit design files
204 construct and levelize a timing graph
206 differentiable global timing optimization
208 incremental static timing analysis for evaluation
802 parallel processing unit
804 I/O unit
806 front-end unit
808 scheduler unit
810 work distribution unit
812 hub
814 crossbar
816 general processing cluster
818 memory partition unit
820 NVLink
822 interconnect
824 memory
902 pipeline manager
904 pre-raster operations unit
906 raster engine
908 work distribution crossbar
910 memory management unit
912 data processing cluster
914 streaming multiprocessor
916 primitive engine
918 M-pipe controller
1002 raster operations unit
1004 level two cache
1006 memory interface
1102 instruction cache
1104 scheduler unit
1106 register file
1108 core
1110 special function unit
1112 load/store unit
1114 interconnect network
1116 shared memory/L1 cache
1118 dispatch
1202 central processing unit
1204 switch
1206 parallel processing module
1302 communications bus
1304 main memory
1306 input devices
1308 display devices
1310 network interface
1402 output data
1404 data assembly
1406 vertex shading
1408 primitive assembly
1410 geometry shading
1412 viewport SCC
1414 rasterization
1416 fragment shading
1418 raster operations
1420 input data
1500 data center
1502 data center infrastructure layer
1504 framework layer
1506 software layer
1508 application layer
1510 resource orchestrator
1512 grouped computing resources
1514a node computing resource
1514b node computing resource
1514c node computing resource
1516 job scheduler
1518 configuration manager
1520 resource manager
1522 distributed file system
1524 software
1526 application(s)

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

1. A process for forming a circuit structure, the process comprising:
weighting arcs in nets of the circuit according to the arcs' gradient contributions to global timing metrics for the circuit structure;
applying differentiable timing propagation to determine the gradient contributions; and
sizing gates of the circuit structure based on timing determined from the weighting of the arcs.

2. The process of claim 1, wherein the global timing metrics comprise one or more of total negative slack and worst negative slack.

3. The process of claim 1, further comprising:
weighting pin-to-pin Manhattan distances by their timing gradients.

4. The process of claim 1, further comprising:
scaling timing objectives for the circuit relative to wirelength and density objectives by aligning magnitudes of the timing gradients.

5. The process of claim 1, further comprising:
initializing timing graphs for the circuit from timing parameters for the circuit output by a static timing analysis tool.

6. The process of claim 1, further comprising:
implementing the differentiable timing propagation with graphics processing unit kernels configured to account for one or more of on-chip variation, rise and fall unateness, and common path pessimism removal.

7. The process of claim 1, wherein the weighting of the arcs is performed iteratively by applying gradient backpropagation.

8. A process for sizing of components in a circuit, the process comprising:
organizing cell arcs and driving net arcs or the cell arcs into stages;
assigning each stage a unique variable for gradient measurement;
determining timing gradients for each stage; and
sizing components in each stage based on the timing gradients.

9. The component sizing process of claim 8, further comprising:
localizing evaluations of component size settings within the circuit.

10. The component sizing process of claim 9, wherein the localizing of evaluations in performed by invoking a Primetime estimate eco function.

11. The component sizing process of claim 8, further comprising:
blocking sizing changes in a local neighborhood of a size-changed stage.
